(19) United States
(12) Patent Application Publication
(10) Pub. No.: US 2003/0133193 A1
(43) Pub. Date: Jul. 17, 2003

(54) Method & apparatus for improving the safety of wheeled vehicles

(76) Inventor: Isidro M. Martinez, San Antonio, TX (US)

Correspondence Address: Mr. William E. Johnson, Jr., The Matthews Firm, Suite 1800, 1900 W. Loop South, Houston, TX, 77027, US

(21) Appl. No.: 10/044,733

(22) Filed: Jan. 11, 2002

(51) Int. Cl. G02B 5/12

(52) U.S. Cl. 359/524; 359/515

(57) ABSTRACT

The tires fabricated from either natural rubber or synthetic rubber are embedded with discrete reflectors of light. The reflectors may be spherical, concave, flat, a regularly shaped, or any other known form of reflector. Those reflectors which are embedded on at least one sidewall surface enable a vehicle having such tires to be seen on unlighted highways based upon the light from an approaching vehicle being reflected off the discrete reflectors back to the eyes of the human driving the approaching vehicle. The process for making such tires involves the mixing of the discrete reflectors with the rubber, followed by vulcanization and then the molding of the rubber tires.

### TECHNICAL FIELD

This invention relates, generally, to improving the safety of wheeled vehicles, and specifically, to providing methods and apparatus for improving the visibility of vehicles when viewed from either side of the vehicle, especially during the nighttime hours.

### BACKGROUND OF THE INVENTION

Reflective materials have been used in the art involving running shoes to add a jogger safety factor in an attempt to prevent or lessen potential pedestrian casualties. It is also known in the bicycle art to provide an accessory which involves reflective devices which can be inserted in the spokes of the bicycle, for example, as is described in U.S. Pat. No. 5,652,677.

In the automotive industry, it has been known to use sidewalls having a white surface, commonly known as “white walls” to dress a vehicle tire instead of just using the plain black rubber tire. In addition, it has also been known to use raised white lettering on the sidewalls of automatic tires to make them more attractive to the purchasing public.

In addition, it is also been well known to use reflective devices, typically on the rear of a vehicle, whether it is a truck, a car, a motorcycle, or a bicycle, to alert an oncoming vehicle that the truck, car or bicycle is just ahead of the oncoming vehicle whenever the lights shine upon the reflective surfaces.

A major problem exist in the motor vehicle industry which has not been previously addressed. During the nighttime hours, especially on streets or highways in which street lighting is not provided, that a vehicle which has been turned sideways for whatever the reason, as often occurs during a vehicular accident, cannot be seen by an approaching vehicle until it is too late to avoid adding to the accident.

### OBJECTS OF THE INVENTION

It is therefore the primary object of the present invention to provide a new and improved process for manufacturing a rubber wheel for use on wheeled vehicles.

It is also an object of the present invention to provide methods and apparatus for improving the visibility of a vehicle which has been turned sideways on a street or highway during the hours of the night.

It is yet another object of the invention to provide a new and improved rubber wheel for use on a wheeled vehicle.

These and other objects, features and advantages will be apparent from a reading of the detailed description of the preferred embodiment of the invention.

### BRIEF DESCRIPTION OF THE DRAWINGS

FIG. 1 is a side elevational view of a conventional panel truck having four conventional rubber wheels on the ground, only two of which can be seen in this view.

FIG. 2 is a side elevational view of a rubber wheel according to the present invention.

FIG. 3 is a block diagram of a process for manufacturing a rubber wheel according to FIG. 2;

FIG. 4 is a schematic view of four different reflectors according to the present invention;

FIG. 5 is a front view of a small segment of a sidewall of a fire having reflectors embedded therein according to the invention;

FIG. 6 is a side, elevated view of a small segment of a sidewall of a tire having reflectors embedded therein according to the invention being struck by light beams from an approaching vehicle; and

FIG. 7 is a schematic view of a light beam from an approaching vehicle striking one of the reflectors illustrated in FIG. 6 and being reflected back to the driver of the approaching vehicle.

### DETAIL DESCRIPTION OF THE PREFERRED EMBODIMENT OF THE INVENTION

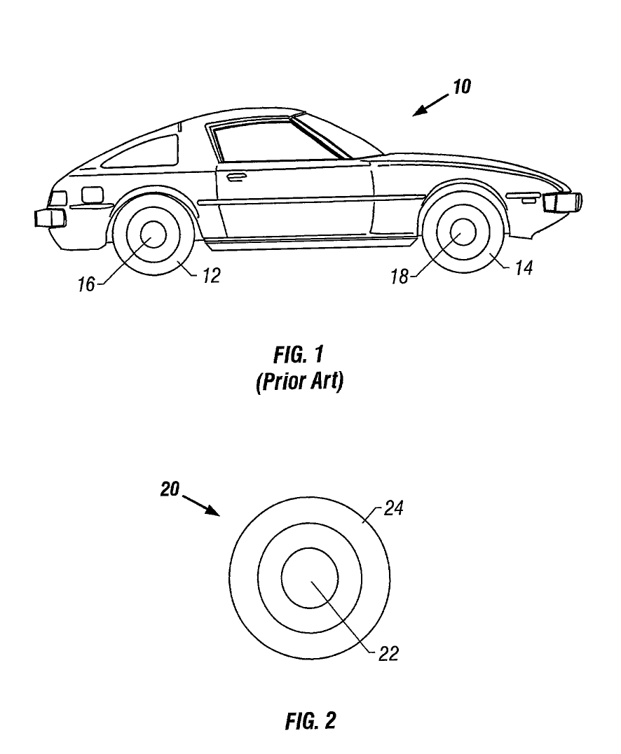

Referring now to FIG. 1, there is illustrated a motorized vehicle 10 which could take many forms, such as a panel truck, a large 18-wheeler truck, a family sedan, or the like. The particular form of vehicle illustrate in FIG. 1 is not important in that the vehicle 10 could take any of the forms of the prior art and still incorporate the present invention. In the particular embodiment illustrated in FIG. 1, the vehicle 10 would have four wheels, with only wheels 12 & 14 being illustrated. As illustrated, the wheels 12 & 14 have no raised lettering and have no whitewalls. As such, if the vehicle 10 is involved in an accident, for example, with another vehicle, on a dark street or dark highway where there is no street lighting or highway lighting, and the vehicle 10 ends up being turned totally sideways, or partially sideways with respect to an oncoming vehicle which is unaware of the accident, the vehicle 10 can oftentimes not be seen by the oncoming vehicle until it is too late to avoid a second collision. The tires 12 & 14 are typically black rubber and provide no indication of anything that can be seen. The hubs 16 & 18 of the wheels 12 and 14, respectively, also do not provide any surface that can typically be seen on a dark night by the lights of an oncoming vehicle. At highway speeds typically in excess of 70 m.p.h., all too often the vehicle 10 when turned sideways cannot be seen by an approaching vehicle in adequate time to avoid another collision.

Referring now to FIG. 2, there is illustrated a tire 20 in accordance with the present invention, having a hub 22 and a sidewall surface 24 which preferably is used to replace all four of the wheels used on the prior art vehicle 10 of FIG. 1. In accordance with the present invention, the sidewalls 24, which can be on one or both sides of the wheel 20, include a reflective material embedded in the tire which may or may not be seen during the daylight hours but which will reflect the headlights from an approaching vehicle, especially during the crucial times when the vehicle 10 has been turned at least partially sideways in the darkened street or highway.

The reflective material used in the sidewalls of the tire 20 can take various forms. It can be used in the rubber compound itself which will cause the entire sidewall to reflect light coming from an oncoming vehicle. It can be in the form of a circular band somewhat like a whitewall band but which will be visible primarily as a result of the oncoming headlights striking the reflective material and coming back to the driver of the oncoming vehicle. It can also take the form of intermittent portions of the sidewall which will appear to be continuous while the vehicle is moving but will only appear as intermittent portions of the sidewalls when the vehicle is not moving.

The present invention also finds utility with tires used on motorcycles and also on bicycles and as such, will replace the reflectors which are described in U.S. Pat. No. 5,652,677.

The invention described herein will increase the visibility of a vehicle, whether motorized or not, and will contribute immensely to the silhouette of a moving or stationary vehicle during the nighttime hours upon any light making contact with the wheels of the invention. It is quite well known that upon leaving any city limits, the lights of a freeway are discontinued and a motorist is typically dependant upon motor vehicle headlights, which illuminate the reflective road markers dividing the lanes of the road. Because of the lack of lights, either upon a highway or upon a street, any vehicle which is turned sideways or partially sideways upon such a darkened highway or street is not visible to an oncoming vehicle. The provision of the reflective material upon the surface of the sidewalls of the tires of a vehicle will result in a significant reduction in traffic accidents, and make every vehicle be more visible to other vehicles as to the position and or the direction of travel of such vehicles during the nighttime hours.

Tires for a wheeled vehicle are typically fabricated from either natural rubber or synthetic rubber. Natural rubber for tires is the vulcanized product of a natural vegetable gum (caoutchouc). Natural rubber is present in the form of tiny droplets in the juice (latex) of the rubber tree (Hevea brasiliensis) which attains a height of 60-80 feet and is grown in plantations in tropical countries.

Synthetic rubber, on the other hand, can be any artificially produced substance that resembles natural rubber in essential chemical and physical properties. Such substances are produced by chemical reactions, known as condensation or polymerization, of certain unsaturated hydrocarbons. The basic units of synthetic rubber are monomers, which are compounds of relatively low molecular weight that form the building units of huge molecules called polymers. After fabrication, the synthetic rubber is cured by vulcanization.

The origin of synthetic-rubber technology can be traced to 1860, when the British chemist Charles Hanson Greville Williams determined that natural rubber was a polymer of the monomer isoprene, which has the chemical formula CH₂:C(CH₃)CH:CH₂. Many efforts were made during the next 70 years to synthesize rubber in the laboratory by using isoprene as the monomer. Other monomers also were investigated, and during World War I (1914-1918) German chemists polymerized dimethylbutadiene (formula CH₂:C(CH₃)C(CH₃):CH₂) producing a synthetic rubber called methyl rubber, which was of limited usefulness.

A breakthrough in synthetic-rubber research did not occur, however, until about 1930, when the American chemist Wallace Hume Carothers and the German scientist Hermann Staudinger did scientific work that contributed greatly to present-day knowledge that polymers are huge, chainlike molecules made of large numbers of monomers, and that synthetic rubber can be prepared from monomers other than isoprene.

Synthetic-rubber research initiated in the United States during World War II led to the synthesis of a polymer of isoprene identical in chemical composition with natural rubber.

One of the first successful synthetic rubbers resulting from Carothers's research was neoprene, which is the polymer of the monomer chloroprene, chemical formula CH₂:C(Cl)CH:CH₂. The raw materials of chloroprene are acetylene and hydrochloric acid. Developed in 1931, neoprene has high resistance to heat and such chemicals as oils and gasoline. Neoprene is used in hose for conveying gasoline and as an insulating material for cables and in machinery.

In 1935 German chemists developed the first of a group of synthetic rubbers called Buna, which is produced by copolymerization-that is, the polymerization of two monomers, called comonomers. The name Buna is derived from the initial letters of butadiene, used as one of the comonomers, and natrium (sodium), which was used as a catalyst. One of these products, BunaN, uses acrylonitrile (CH₂:CH(CN)) as the other comonomer. Acrylonitrile is produced from cyanide. Buna-N is valuable for uses requiring resistance to the action of oils or abrasion.

During World War II a Buna-type rubber called GR-S (Government Rubber-Styrene) was designated as the general-purpose rubber for the U.S. war effort. The basic rubber produced by the present-day U.S. synthetic-rubber industry, GR-S, is a copolymer of butadiene and styrene. The various grades of GR-S are classified in two categories, regular and cold, depending on the temperatures of copolymerization. Cold GR-S types, which exhibit superior properties, are prepared at 5° C. (41° F.); regular GR-S types are prepared at temperatures of 50° C. (122° F.). Cold GR-S is used to make longer-wearing tires for automobiles and trucks.

Many other types of synthetic rubber are produced in the United States, mostly by methods similar to those described above. Certain changes in the process or the polymerization recipes have succeeded in improving quality as well as reducing production costs. In one outstanding development, petroleum oil was used as an additive; it lowered the cost by conserving a substantial amount of synthetic-rubber stock. Tires made from such oil-extended rubber are very durable.

The name “Buna” is applied to a group of synthetic rubbers first developed in Germany and is produced by a process of polymerization from butadiene with sodium (natrium) as a catalyst. The process used to be carried out at a temperature of about +50° C. and yielded “lettered” Buna rubbers such as, for example, Buna S (butadiene styrene rubber). Nowadays copolymerization of butadiene and styrene is mostly done in aqueous phase. With the newer activators it is possible to carry out this process at about +5° C., whereby the present form known as “cold rubber” is obtained. By appropriate variation of the monomers, their proportions (chiefly about 75% butadiene and 25% styrene) and the polymerization conditions, a number of different types of Buna rubber are obtained, and this range of types can be further extended by various methods of processing and by using various admixtures. Lately, with aid of so-called Ziegler catalysts, a product bearing a closer resemblance to natural rubber can also be produced from butadiene or isoprene, e.g., Buna CB (poly-cis-butadiene).

In the emulsion copolymerization process carried out at +5° C. (as referred to above) the hydrocarbons to be polymerized (e.g., butadiene and styrene) are in emulsion and contain a constituent of the activator system dissolved in them. The second part of the activator system is present in the aqueous phase (the watery medium of the emulsion). The combined activator system initiates the process of polymerization. The molecule size of the polymer obtained can be regulated by certain added substances. The macromolecules (giant molecules of very great length) formed in this way have a filamentary structure with branches, so-called side chains. The polymerization of the monomers is stopped after about 60% of these substances have reacted. The resultant product at this stage is a latex rather like the latex of natural rubber. The unreacted monomers are removed from this latex, and stabilizers are added to it, whereafter the latex is coagulated by the addition of acids and salts. The solid matter obtained in this way is washed and dried in several stages.

For processing Buna into rubber goods, it is treated in masticating machines or on mixing rollers, various substances being added whereby the workability of the rubber and/or the properties of the vulcanizates are controlled. Such admixtures are, for example: oils, paraffin, fatty acids, tars, bitumen, carbon black, zinc oxide, chalk, silica, kaolin, finely divided organic and inorganic substances. For vulcanization, which is usually carried out under pressure at approximately 150° C., the mixture moreover has sulphur and vulcanization accelerator (e.g., mercapto benzothiazole) added to it.

In the process ofvulcanization the filamentary molecules become interlinked into a three-dimensional network, the “links” between the molecules being formed by sulphur. The process is known as cross-linking. As a result, the rubber largely loses its plastic properties and instead, acquires a high degree of elasticity and other properties associated with manufactured rubber (e.g. wear resistance). Buna is used for making motor tires, rubber conveyor belts, and many other technical products.

Vulcanization or curing is a chemical reaction whereby the filamentary molecules of rubber are interlinked into a three-dimensional network, this being usually achieved with the aid of sulphur. Sometimes peroxides are used for the purpose, however. It was Goodyear who, in 1839, first masticated crude rubber with sulphur and heated the mixture to 130° C. After undergoing this treatment, the rubber was no longer plastically deformable but, instead, acquired a high degree of resilience which was retained over a wide range of temperatures. The solubility of crude rubber in petrol is greater than that of vulcanized rubber.

Because of the wide range of products for which rubber is used (e.g., motor tires, tubing, seals, footwear, gloves, etc.), it is necessary to incorporate other admixtures besides sulphur into the crude rubber. Various substances are mixed into the rubber in masticating machines or on roll mills, e.g., carbon black (for high abrasion resistance), silicia, chalk, asbestos (more particularly for brake linings), oils (for better workability of the mixture), paraffin (for better resistance to light), antioxidants (usually: aromatic amines or phenol derivatives), activators (usually zinc oxide), and various organic and inorganic colouring substances. In order to speed up the vulcanization process and to improve the properties of the vulcanizates, various accelerators are added, e.g., dithio carbamic acid derivatives, mercapto benzothiazole derivatives, diphenylguanidine, etc.

Vulcanization is carried out under pressure in moulds at temperatures around 150° C. and takes from a few minutes to several hours, depending on the vulcanization temperature and the size of the rubber article concerned. Vulcanizing an ordinary motor tyre takes about half an hour. By using special combinations of accelerators it is also possible to perform the vulcanization process at ordinary room temperature. Some rubber mixtures are manufactured into various special sections (tubes, sealing gaskets for car windows, etc.) by extrusion. Such extruded articles are vulcanized under pressure in vulcanizing vessels. Other mixtures are processed by calendering, i.e., the rubber is pressed between rolls to form sheets of predetermined size and thickness.

Sponge rubber is usually produced from latex, which is foamed by various methods and then vulcanized. Certain rubber mixtures can be bonded to metals so as to establish a permanent connection. Soft rubber contains about 1.5-5.5 and hard rubber contains about 15-30% sulphur. In cases where rubber goods have to fulfil special requirements—e.g., high resistance to swelling in organic solvents, to the action of light, or to high temperatures—it may be necessary to use certain synthetic rubbers, such as Perbunan or butyl rubber.

The processes described above are well known in the tire manufacturing industry. However, the worldwide industry has continued to manufacture hundreds of millions of black rubber tires, both from natural rubber and synthetic rubber, which can not be seen on unlighted streets and highways.

As referenced above, the amount of light reflected back to an oncoming car off of the tires fabricated in accordance with the present invention is a factor of the type of reflectors embedded on the sidewall surfaces of the wheels, the volume of each of the embedded reflectors and the number of reflectors for any given segment of the sidewall surface, for example, per square inch.

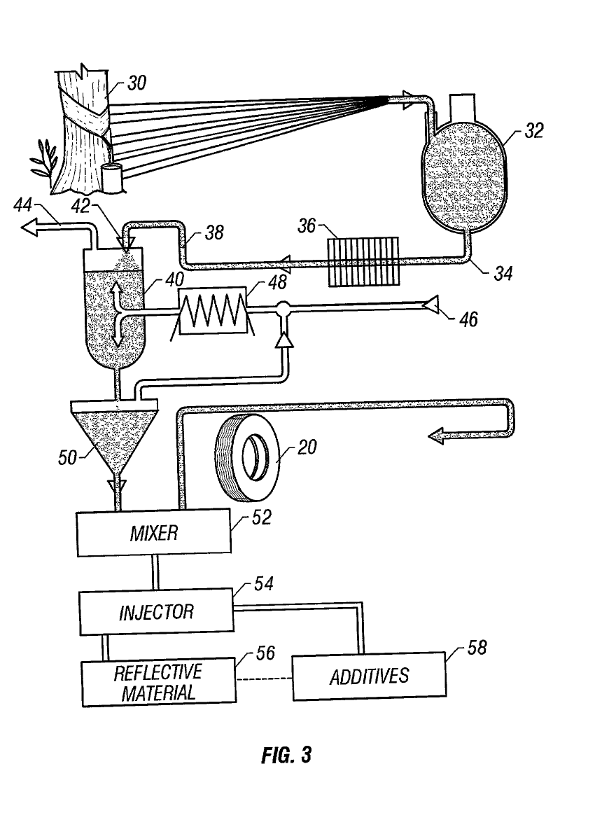

Referring now to FIG. 3, there is a block diagram, pictorial view of a process for manufacturing a tower from natural rubber in accordance with the present invention. The process for manufacturing the tire from natural rubber commences with latex being tapped from a natural rubber tree 30 which is then collected and placed into a latex container 32 in a manner well known in the art. The latex passes through a conduit 34 which is connected through a filtration unit 36, the output of which passes through a conduit 38 into a tank 40 through a spray nozzle 42. The tank 40 also has an exhaust outlet 44 for exhausting the air from the top of the tank 40. A fresh air intake 46 allows the fresh air to be coupled into a heating unit 48 which allows the heated air to be coupled into the interior of the tank 40 which causes the hot air to bubble through the latex within the tank 40, at the lower end of the tank 40, the latex is drained into a separator 50 which couples the dry powder latex into a mixer tank 52 whose output is connected into a conventional vulcanization unit which is then coupled into a conventional molding apparatus, in this case being a conventional tire molding unit to result in the manufacture of the tire 20 illustrated in FIG. 2.

Also coupled into the mixer 52 is an injector unit 54 which has as its inputs the materials from the reflective material container 56 and from the various additives 58 which are described hereinbefore within the specification.

The make-up and volume of the reflective materials being injected into the mixer 52 from the hopper 56 determines the extent of light being reflected back to the driver of a car approaching a wrecked car which has been turned sideways on a darkened highway. As is well known, the reflection of light and other forms of electromagnetic radiation occurs when waves encounter a boundary that does not absorb the radiation's energy and bounces the waves off the surface. The incoming light wave is referred to as an incident wave and the wave that is bounced from the surface is called the reflected wave. This simple concept is nicely illustrated with a flashlight and glass mirror.

Visible white light emitted by the flashlight bulb is directed onto the surface of a mirror at an angle (incident). This light then is reflected back into space at another angle (reflected) that is equal to the incident angle. Thus, the angle of incidence is equal to the angle of reflection for visible light as well as other wavelengths of electromagnetic radiation. This concept is often termed the law of reflection. The best surfaces for reflecting light are very smooth such as a glass mirror and polished metal, although almost all surfaces will reflect light to some degree.

The amount of light reflected by an object is very dependent upon the texture of the surface. When surface imperfections are smaller than the wavelength of the incident light (as in the case of a mirror), virtually all of the light is reflected. However, in the real world most objects have convoluted surfaces that exhibit a diffuse reflection, with the incident light being reflected in all directions. Almost everything that we see (people, cars, houses, animals, trees, etc.) does not emit visible light but reflects incident natural sunlight and artificial light. For instance, an apple appears a shiny red color because it has a relatively smooth surface that absorbs other non-red (such as green, blue, yellow) wavelengths of light. The reflection of light can be roughly categorized into two types of reflection: specular reflection is defined as light reflected from a smooth surface at a definite angle, as demonstrated above with the flashlight, and; diffuse reflection, which is produced by rough surfaces that tend to reflect light in all directions.

In addition to flat surfaces and irregular surfaces, there are convex surfaces and concave surfaces, each of which will also reflect light.

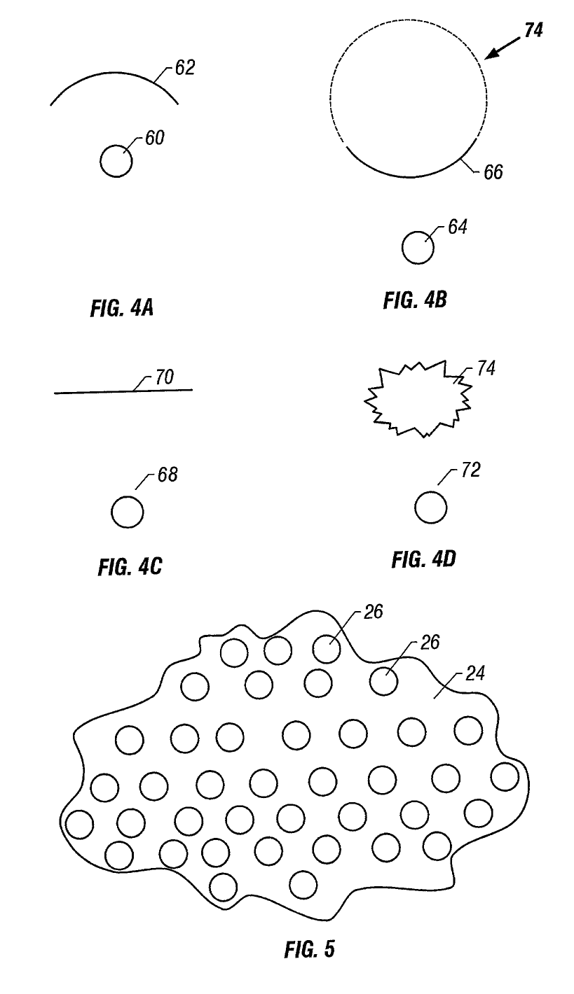

As illustrated in FIG. 4(a)-(d), the four distinct reflective surfaces are illustrated with respect to four light sources, respectively. In FIG. 4a), a light source 60 is positioned with respect to a concave surface 62. In FIG. 4b), a light source 64 is positioned with respect to a convex surface 66. Of note, the surface 66 is only a portion of the round object 74, discussed hereinafter, as shown by the dashed line completing the circle. In FIG. 4c), the flat surface 70 is positioned with respect to a light source 68. In FIG. 4d), a light source 72 is positioned with respect to an irregular shaped surface 74.

In addition to the four light reflectors illustrated in FIG. 4, the reflectors used according to the present invention could have various other geometric configurations, for example, square cubes, and the like, and combinations thereof.

However, the preferred embodiment is the use of the spherical reflector 74 illustrated in FIG. 4(b), while the reflector 74 could be manufactured from various materials, to provide a reflector having good reflective qualities, it is preferably manufactured as glass spheres, polished aluminum and/or polished steel spheres will also function as such reflectors. Of note, a sphere is the only geometric configuration which requires no alignment to function as a reflector.

The amount of light reflected from a tire back to an ongoing driver is a function of reflectors per cubic inch of the rubber tire and also the diameter of the individual spheres. The mixer 52 will provide a constant, uniform distribution of the spheres throughout the rubber tires. The diameter of the spheres should preferably be maintained small, for example, a few microns, to provide an aesthetic appearance on the sidewall surfaces. If it is desired to have the heaviest concentration of spheres on the sidewall surfaces, the tires can be spinning at 90° from the axis of rotation during use on a vehicle, to cause the spheres, through centrifugal force, to move to the sidewall during the vulcanization and or molding process.

Referring now to FIG. 5 of the drawing, there is illustrated a small segment of the sidewall 24 illustrated in FIG. 2. Embedded within the tire 20 is a plurality of discrete reflectors 26, only two of which are shown as being numbered. In the preferred embodiment, the reflectors 26 are embedded in a random nature throughout the tire 20 but only the ones which are at least partially extending through the sidewall surface will act as reflectors to the light coming from an oncoming vehicle. The preferred embodiment contemplates that the reflectors are spherical since they will reflect light from any angle but the reflector 26 may also take any of the forms illustrated in FIG. 4 and they also take any other form which will reflect light back to the oncoming vehicle.

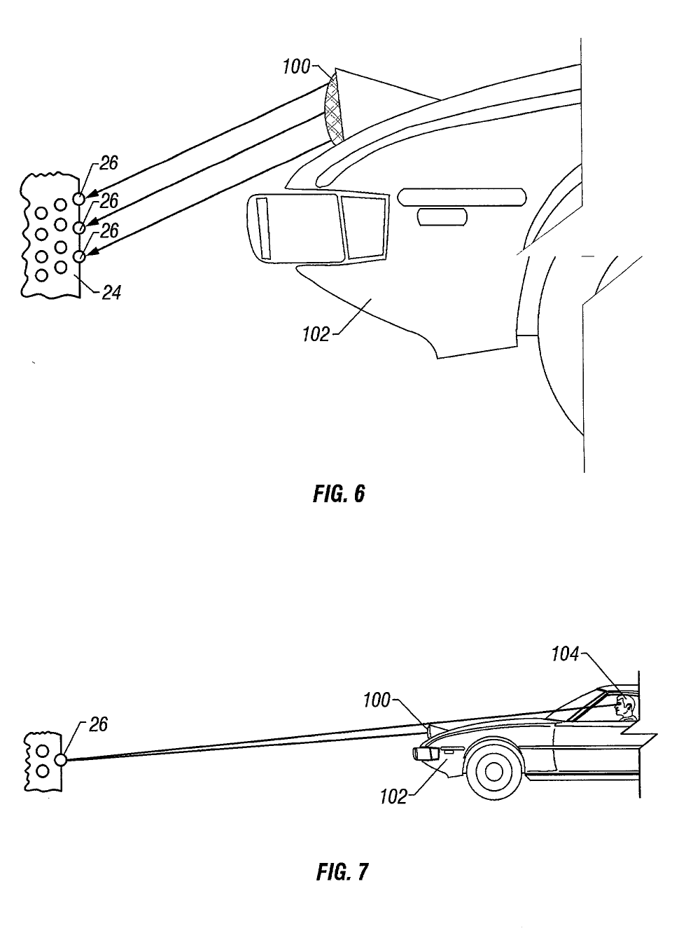

Referring now to FIG. 6, there is a side elevational view of the small segment illustrated in FIG. 5 which shows three reflectors 26 embedded within the sidewall 24 of the tire illustrated in FIG. 2. The other reflectors illustrated in FIG. 6 are embedded within the tire and would not provide a reflector for light coming in from an approaching vehicle. FIG. 6 also illustrates a headlight 100 on the front end of an approaching automobile 102 and illustrates light beams from the source 100 striking against the reflectors 26.

FIG. 7 illustrates the fact that when the light beams from the headlights 100 mounted on the front end of the vehicle 102 strike the reflector 26, because of its spherical reflection surface, the light beam from the source will be reflected back from the reflector 26 to the eyes of the human 104 located within the vehicle 102.

Thus there has been described herein the preferred embodiment of the present invention in which the rubber tires can be fabricated from either natural rubber or from synthetic rubber. Although the preferred embodiment contemplates that the reflectors are spherical, they can also be fabricated with all of the various shapes and formulations known in the art of dealing with reflective materials. Moreover, while the invention contemplates the use of very small reflectors, for example, spherical shaped reflectors having diameters of a few microns up to a few hundred microns. Quite obviously, the number of such reflectors per unit volume can also affect the amount of light which will be reflected back to an oncoming vehicle. The preferred embodiment for commercialization of the tires fabricated in accordance with this invention will provide some optimization of the diameter of the a given spherical reflectors and also the number of such reflectors to be utilized to provide an optimum reflecting sidewall on the tire but which will not unduly affect the overall performance of the tire.

unduly affect the overall performance of the tire.

1. A rubber tire comprised of:
a rubber body having an outer sidewall, an inner sidewall and a tread surface connected between said sidewalls, said outer sidewall having embodied therein a plurality of discrete reflectors.

2. The tire according to claim 1 wherein said rubber body is comprised of natural rubber.

3. The tire according to claim 1 wherein said rubber body is comprised of synthetic rubber.

4. The tire according to claim 1 wherein said reflectors are spherical.

5. The tire according to claim 4 wherein said spherical reflectors are glass.

6. The tire according to claim 1 wherein said reflectors are concave.

7. The tire according to claim 1 wherein said reflectors are flat.

8. The tire according to claim 1 wherein said reflectors are irregularly shaped.

9. A process for manufacturing a rubber tire, comprising:
injecting a plurality of discrete reflectors into a mixer;
injecting rubber into said mixer;
vulcanizing the mixture of discrete reflectors and rubber; and
molding said vulcanized mixture into a rubber tire.

10. The process according to claim 9 wherein said reflectors are spherical.

11. The process according to claim 10 wherein said spherical reflectors are glass.

12. The process according to claim 9 wherein said reflectors are concave.

13. The process according to claim 9 wherein said reflectors are flat.
